(19) United States
(12) Patent Application Publication
(10) Pub. No.: US 2026/0050464 A1
(43) Pub. Date: Feb. 19, 2026

(54) Identifying Needed Resource Dependencies to Increase Deployment Efficiency in Container-Based Environments

(71) Applicant: International Business Machines Corporation, Armonk, NY (US)

(72) Inventors: Jie Ke Fang, Beijing (CN); Xiao Ling Chen, Beijing (CN); Heng Wang, Beijing (CN); Shi Su, Beijing (CN)

(21) Appl. No.: 18/805,796

(22) Filed: Aug. 15, 2024

(51) Int. Cl. G06F 9/455; G06F 9/50

(52) U.S. Cl. CPC G06F 9/45558; G06F 9/5077; G06F 2009/4557; G06F 2009/45591; G06F 2009/45595

(57) ABSTRACT

A resource deployment health report graph that defines a first plurality of resource dependencies set as a needed resource dependency type and a second plurality of resource dependencies set as an optional resource dependency type is generated prior to resources being connected in a container-based environment. An analysis of the resource deployment health report graph is performed to determine a status of each of the first plurality of resource dependencies and each of the second plurality of resource dependencies. It is determined whether each of the first plurality of resource dependencies and the second plurality of resource dependencies is marked ready in the resource deployment health report graph based on the analysis. In response to determining that each of the first plurality of resource dependencies and the second plurality of resource dependencies is marked ready, it is determined that an actual deployment is successfully implemented in the container-based environment.

### BACKGROUND

The disclosure relates generally to container-based environments and more specifically to deploying resources in a container-based environment.

A container-based environment, architecture, or platform, such as, for example, Kubernetes® (a registered trademark of the Linux Foundation of San Francisco, California, USA), provides a structure for automating deployment, scaling, and operations of application workloads across clusters of host nodes. Typically, a container-based environment includes, for example, a control node, which is a main controlling unit of a cluster of host nodes, managing the cluster's workload, and directing communication across the cluster. A host node is a machine, either physical or virtual, where an application workload is deployed. The host node hosts components of the application workload.

The control plane of the cluster of host nodes, which the control node forms, consists of various components, such as, for example, a data store, application programming interface (API) server, scheduler, and the like. The data store contains configuration data of the cluster, representing the overall and desired state of the cluster at any given time. The API server provides internal and external interfaces for the control node. The API server processes and validates resource availability (e.g., resource status) and updates state of objects in the data store, thereby allowing users to configure application workloads across host nodes in the cluster. The scheduler selects which host node a workload runs on.

### SUMMARY

According to one illustrative embodiment, a method is provided. A resource deployment health report graph that defines a first plurality of resource dependencies set as a needed resource dependency type and a second plurality of resource dependencies set as an optional resource dependency type along with a status of each of the first plurality of resource dependencies set as the needed resource dependency type and of each the second plurality of resource dependencies set as the optional resource dependency type is generated prior to resources being connected in a container-based environment. An analysis of the resource deployment health report graph is performed to determine the status of each of the first plurality of resource dependencies set as the needed resource dependency type and each of the second plurality of resource dependencies set as the optional resource dependency type. It is determined whether each of the first plurality of resource dependencies set as the needed resource dependency type and the second plurality of resource dependencies set as the optional resource dependency type is marked as ready in the resource deployment health report graph based on the analysis of the resource deployment health report graph. In response to determining that each of the first plurality of resource dependencies set as the needed resource dependency type and the second plurality of resource dependencies set as the optional resource dependency type is marked as ready in the resource deployment health report graph based on the analysis of the resource deployment health report graph, it is determined that an actual deployment in the container-based environment that is reflected by a virtual deployment corresponding to the container-based environment is in a healthy state and that the actual deployment is successfully implemented in the container-based environment. According to other illustrative embodiments, a computer system and computer program product are provided.

### BRIEF DESCRIPTION OF THE DRAWINGS

FIG. 1 is a pictorial representation of a computing environment in which illustrative embodiments may be implemented;

FIG. 2 is a diagram illustrating an example of a needed resource dependency identification system in accordance with an illustrative embodiment;

FIG. 3 is a diagram illustrating an example of playbooks in accordance with an illustrative embodiment;

FIG. 4 is a diagram illustrating an example of a needed resource dependency path identification process in accordance with an illustrative embodiment;

FIG. 5 is a diagram illustrating an example of resource dependency objects in a resource deployment health report graph in accordance with an illustrative embodiment;

FIG. 6 is a diagram illustrating an example of a generative resource dependency registry in accordance with an illustrative embodiment; and

FIGS. 7A-7C are a flowchart illustrating a process for identifying needed resource dependencies in container-based environments in accordance with an illustrative embodiment.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc), or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

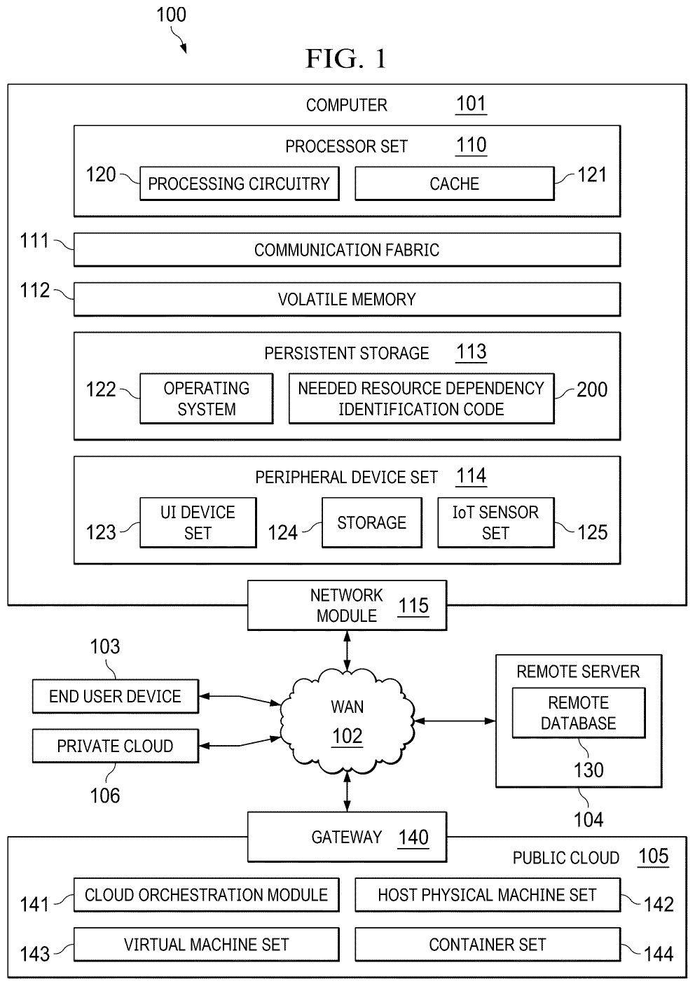

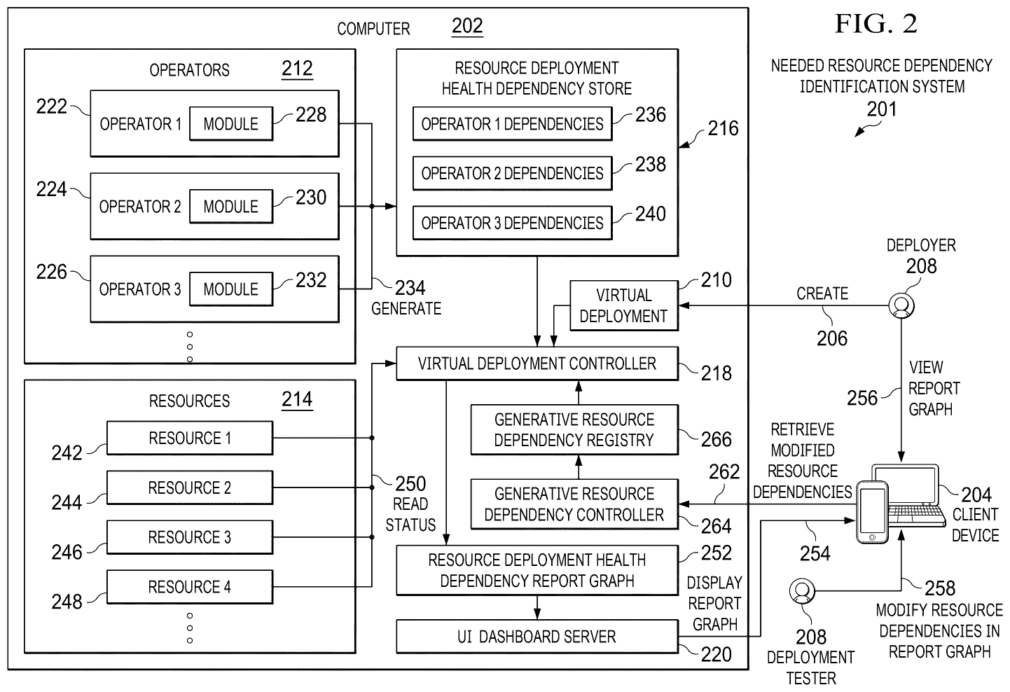

With reference now to the figures, and in particular, with reference to FIG. 1 and FIG. 2, diagrams of data processing environments are provided in which illustrative embodiments may be implemented. It should be appreciated that FIG. 1 and FIG. 2 are only meant as examples and are not intended to assert or imply any limitation with regard to the environments in which different embodiments may be implemented. Many modifications to the depicted environments may be made.

FIG. 1 shows a pictorial representation of a computing environment in which illustrative embodiments may be implemented. Computing environment 100 contains an example of a container-based environment for the execution of at least some of the computer code involved in performing the inventive methods of illustrative embodiments, such as needed resource dependency identification code 200.

For example, needed resource dependency identification code 200 identifies critical resource dependency paths and non-critical resource dependency paths among resources (e.g., application workloads) corresponding to a container-based environment using definitions contained in tasks of one or more playbooks. A playbook includes a set of tasks that is automatically executed in a predefined order. The resources can include a plurality of resources located locally in the container-based environment and a set of resources located remotely outside the container-based environment. Furthermore, needed resource dependency identification code 200 generates a resource deployment health report graph showing both resource dependencies and business dependencies during initial deployment without needing real connections between resources in the container-based environment. In other words, needed resource dependency identification code 200 does not need to have real connections between resources to identify the status of each resource and any corresponding resource dependencies.

A resource dependency is another resource that a resource (i.e., a dependent resource) depends on to run or perform its corresponding service or task. A resource dependency path is a set of other resources that the dependent resource depends on to run or perform its corresponding service or task. In other words, if one or more of the set of other resources is not ready, missing, or the like, then the dependent resource cannot run or perform its corresponding service or task. A critical resource dependency is a resource that is required or necessary for functionality of a deployment in the container-based environment. A non-critical resource dependency is a resource that is optional for the functionality of the deployment in the container-based environment.

Needed resource dependency identification code 200 automatically saves critical and non-critical resource dependency information in a table, YAML file, configuration map, or the like within a generative resource dependency registry using a generative resource dependency controller. As a result, needed resource dependency identification code 200 can directly show the complex resource dependencies via the resource deployment health report graph based on the critical and non-critical resource dependency information. Thus, needed resource dependency identification code 200 enables deployment developers to debug deployments and customers to understand the software product logic. Moreover, needed resource dependency identification code 200 enables a site reliability engineer to identify and resolve any problematic critical resource dependencies to restore the system to a healthy state quickly and efficiently. For example, needed resource dependency identification code 200 identifies and indicates the status (e.g., ready, not ready, missing, should not exist, or the like) of each resource of a particular deployment in the container-based environment using the resource deployment health report graph.

In addition to needed resource dependency identification code 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and needed resource dependency identification code 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a mainframe computer, quantum computer, desktop computer, laptop computer, tablet computer, or any other form of computer now known or to be developed in the future that is capable of, for example, running a program, accessing a network, and querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods of illustrative embodiments may be stored in needed resource dependency identification code 200 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports, and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data, and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks, and even connections made through wide area networks such as the internet. In various embodiments, UI device set 123 may include components such as a display screen, speaker, microphone, wearable devices (such as smart glasses and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (e.g., where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (e.g., embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (e.g., the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

EUD 103 is any computer system that is used and controlled by an end user (e.g., a system administrator, deployment developer, deployer, deployment tester, or the like who utilizes the needed resource dependency identification services provided by computer 101), and may take any of the forms discussed above in connection with computer 101. EUD 103 typically receives helpful and useful data from the operations of computer 101. For example, in a hypothetical case where computer 101 is designed to provide a resource deployment health report graph showing critical and non-critical resource dependency paths to the end user, this resource deployment health report graph would typically be communicated from network module 115 of computer 101 through WAN 102 to EUD 103. In this way, EUD 103 can display, or otherwise present, the recommendation to the end user. In some embodiments, EUD 103 may be a client device, such as thin client, heavy client, mainframe computer, desktop computer, laptop computer, tablet computer, smart phone, smart watch, and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a resource deployment health report graph based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single entity. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Public cloud 105 and private cloud 106 are programmed and configured to deliver cloud computing services and/or microservices (not separately shown in FIG. 1). Unless otherwise indicated, the word “microservices” shall be interpreted as inclusive of larger “services” regardless of size. Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of application programming interfaces (APIs). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

As used herein, when used with reference to items, “a set of” means one or more of the items. For example, a set of clouds is one or more different types of cloud environments. Similarly, “a number of,” when used with reference to items, means one or more of the items. Moreover, “a group of” or “a plurality of” when used with reference to items, means two or more of the items.

Further, the term “at least one of,” when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item B. This example may also include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

Container-based environments, such as, for example, Kubernetes, have become the predominant standard for container orchestration. When deploying a system (e.g., a containerized application) in a container-based environment for the first time, customers often encounter confusion regarding expected deployment topology, especially when faced with deployment issues. For example, complex dependencies exist between resources, such as, for example, replica sets, service accounts, secrets, custom resource definitions, deployments, and the like, which can lead to issues in a container-based environment.

Some existing products offer solutions for visualizing resource (e.g., workload) dependencies by monitoring real time network invocations between resources and drawing invocation chain diagrams between deployed containers running the resources. However, these existing solutions rely on a successfully deployed system and cannot address deployment issues, such as missing resources or resources in an unhealthy state due to one or more resource dependencies not being in a ready state. In addition, using existing solutions, customers cannot determine critical resource dependencies to resolve the deployment issues. In other words, a customer cannot determine which resource dependency is a critical resource dependency that needs to be resolved first to increase deployment efficiency in the container-based environment. Similarly, the customer cannot determine which resource dependency is a non-critical resource dependency that does not impact core functionality of the container-based environment and can be resolved at a later time. Further, existing solutions do not provide a mechanism for deployment developers, deployers, and deployment testers to collaborate in real time to resolve deployment issues. For example, when a deployment developer makes a mistake on a resource dependency relationship, resolving that resource dependency issue requires a code fix, which is time consuming. However, the deployer or deployment tester may be able to resolve the resource dependency issue but cannot make the resource dependency relationship correction in real time because existing solutions do not provide such a mechanism.

These types of issues occur when the software product is large, and several deployment developers are responsible for developing different components of the application. As a result, a complete picture of the deployment is not available for the deployment developer to review to determine which resource dependencies are critical and which are non-critical for the deployment. In addition, the dependencies between resources can be complex with no clear correlation between the resource dependencies and resolution to any resource dependency issue is needed quickly for the deployment to be successful.

Illustrative embodiments diagnose the deployment health of resources by identifying critical resource dependency paths and non-critical resource dependency paths to help a user, such as, for example, a deployment developer, deployer, deployment tester, system administrator, or the like, to understand resource dependency relationships to resolve any deployment issues related to critical resource dependencies first during an initial deployment in the container-based environment. Furthermore, illustrative embodiments enable collaboration between the deployment developer, deployer, and deployment tester so that the deployer or deployment tester can modify or adjust in real time one or more resource dependencies, which the deployment developer defined incorrectly, to quickly resolve issues related to critical resource dependencies.

Illustrative embodiments generate a resource deployment health dependency graph, which shows the status (e.g., ready, not-ready, missing, or should-not-exist) of each resource in the container-based environment for an initial deployment. Illustrative embodiments utilize a set of tasks, which identifies resource internal dependencies, resource external dependencies, and resource deployment preconditions, to determine the status of each resource during resource deployment in the container-based environment.

Illustrative embodiments utilize a resource deployment health dependency module to parse the set of tasks to identify each dependency of each particular resource corresponding to each operator in the container-based environment and then aggregate the resource dependencies of each operator. The resource deployment health dependency module, which is located in each respective operator, stores each identified resource dependency corresponding to each particular operator in a resource deployment health dependency store. An operator in a container-based environment is an application-specific controller that extends the functionality of the API server in the container-based environment to generate, configure, and manage instances of complex applications on behalf of a user of the container-based environment.

Illustrative embodiments also utilize a virtual deployment custom resource to represent different virtual deployments for a specific target system. The deployer creates a specific custom virtual deployment according to an implemented real deployment. In addition, the deployer can create multiple virtual deployments based on multiple actual deployments.

Illustrative embodiments utilize a virtual deployment controller to analyze a file (e.g., a YAML file), which contains the definition for the resource deployment health dependency graph, analyze resource dependencies contained in the resource deployment health dependency store, and analyze a specific virtual deployment custom resource to generate the resource deployment health dependency graph. The resource deployment health dependency graph represents the relationships between resources, dependencies of each respective resource, and any deployment preconditions corresponding to a particular resource. The virtual deployment controller also generates a resource deployment health report graph for each specific virtual deployment based on the resource deployment health dependency graph for that particular virtual deployment. Illustrative embodiments utilize a user interface (UI) dashboard server to display the generated resource deployment health report graph to a user.

Illustrative embodiments utilize a new definition in a task of a playbook to represent the extended resource dependency relationships. The new definition is a “dependency_type” parameter representing either a critical or needed resource dependency relationship between resources or a non-critical or optional resource dependency relationship between resources.

Illustrative embodiments utilize a generative resource dependency controller to monitor for and retrieve in real time resource dependency modifications that a deployer or deployment tester have made to the resource deployment health report graph. The generative resource dependency controller saves the resource dependency modifications in a generative resource dependency registry. The generative resource dependency registry is a storage space for the modified or changed resource dependency relationships between resources in the container-based environment.

Illustrative embodiments utilize the virtual deployment controller to analyze and merge the resource dependencies stored in a resource deployment health dependency store, which were created by the deployment developer, and the resource dependency modifications stored in the generative resource dependency registry, which were created by at least one of the deployer or the deployment tester, according to defined rules to update the resource deployment health report graph in real time. Illustrative embodiments display the updated resource deployment health report graph in the UI in real time. As a result, illustrative embodiments enable a user to quickly resolve any deployment issue corresponding to critical resources by following critical resource dependency paths in the updated resource deployment health report graph.

Thus, illustrative embodiments provide one or more technical solutions that overcome a technical problem with an inability of existing solutions to identify critical resource dependency paths to resolve deployment issues in container-based environments in real time. As a result, these one or more technical solutions provide a technical effect and practical application in the field of container-based environments.

With reference now to FIG. 2, a diagram illustrating an example of a needed resource dependency identification system is depicted in accordance with an illustrative embodiment. Needed resource dependency identification system 201 may be implemented in a computing environment, such as computing environment 100 in FIG. 1. Needed resource dependency identification system 201 is a system of hardware and software components for identifying critical resource dependency paths and non-critical resource dependency paths to quickly resolve any deployment issues related to critical resource dependencies first during an initial deployment in the container-based environment.

In this example, needed resource dependency identification system 201 includes computer 202 and client device 204. Computer 202 can be, for example, computer 101 in FIG. 1. Client device 204 can be, for example, EUD 103 in FIG. 1. However, it should be noted that needed resource dependency identification system 201 is intended as an example only and not as a limitation on illustrative embodiments. For example, needed resource dependency identification system 201 can include any number of computers, client devices, and other devices and components not shown.

At 206, deployer 208 (e.g., a system administrator or the like) creates virtual deployment 210, which is based on an actual or real deployment implemented by a deployment developer, and inputs virtual deployment 210 in computer 202 using client device 204, for example. Virtual deployment 210 is a custom resource that defines a specific custom virtual deployment for the container-based environment. In this example, computer 202 includes operators 212, resources 214, resource deployment health dependency store 216, virtual deployment controller 218, UI dashboard server 220, and generative resource dependency controller 264. However, computer 202 is intended as an example only and can include any number of other components not shown.

In this example, operators 212 include operator 1 222, operator 2 224, and operator 3 226. Operator 1 222 contains resource deployment health dependency module 228, operator 2 224 contains resource deployment health dependency module 230, and operator 3 226 contains resource deployment health dependency module 232.

At 234, operator 1 222 utilizes resource deployment health dependency module 228 to generate operator 1 resource dependencies 236, operator 2 224 utilizes resource deployment health dependency module 230 to generate operator 2 resource dependencies 238, and operator 3 226 utilizes resource deployment health dependency module 232 to generate operator 3 resource dependencies 240. Operator 1 resource dependencies 236, operator 2 resource dependencies 238, and operator 3 resource dependencies 240 represent dependencies of resources corresponding to virtual deployment 210. Resource deployment health dependency module 228, resource deployment health dependency module 230, and resource deployment health dependency module 232 store operator 1 resource dependencies 236, operator 2 resource dependencies 238, and operator 3 resource dependencies 240, respectively, in resource deployment health dependency store 216.

In this example, resources 214 include resource 1 242, resource 2 244, resource 3 246, and resource 4 248. Resource 1 242, resource 2 244, resource 3 246, and resource 4 248 represent different workloads corresponding to one or more containerized applications. At 250, virtual deployment controller 218 reads the status of resource 1 242, resource 2 244, resource 3 246, and resource 4 248 that virtual deployment controller 218 retrieved from an API server. It should be noted that the API server can be located locally in computer 202 or can be located remotely in another computer of the container-based environment. In addition, virtual deployment controller 218 analyzes virtual deployment 210 and analyzes operator 1 resource dependencies 236, operator 2 resource dependencies 238, and operator 3 resource dependencies 240 corresponding to virtual deployment 210.

Based on reading the status of resource 1 242, resource 2 244, resource 3 246, and resource 4 248 and analyzing virtual deployment 210 and operator 1 resource dependencies 236, operator 2 resource dependencies 238, and operator 3 resource dependencies 240 corresponding to virtual deployment 210, virtual deployment controller 218 generates resource deployment health report graph 252. Resource deployment health report graph 252 shows all the resources dependencies, the status of each resource, the status of each resource dependency, each critical resource dependency path, and each non-critical resource dependency path corresponding to virtual deployment 210.

Virtual deployment controller 218 inputs resource deployment health report graph 252 in UI dashboard server 220. At 254, UI dashboard server 220 reads resource deployment health report graph 252 and displays resource deployment health report graph 252 in client device 204. At 256, deployer 208 views resource deployment health report graph 252. At 258, deployment tester 260 reviews and then modifies a set of resource dependencies in resource deployment health report graph 252 to resolve any deployment issues with unhealthy resources in the actual deployment.

At 262, generative resource dependency controller 264 monitors for and retrieves in real time the set of modified resource dependencies made by deployment tester 260 in resource deployment health report graph 252. Generative resource dependency controller 264 stores the set of modified resource dependencies in generative resource dependency registry 266. Virtual deployment controller 218 retrieves the set of modified resource dependencies from generative resource dependency registry 266. Virtual deployment controller 218 automatically merges the set of modified resource dependencies retrieved from generative resource dependency registry 266 with operator 1 resource dependencies 236, operator 2 resource dependencies 238, and operator 3 resource dependencies 240 corresponding to virtual deployment 210 to generate an updated resource deployment health report graph 252.

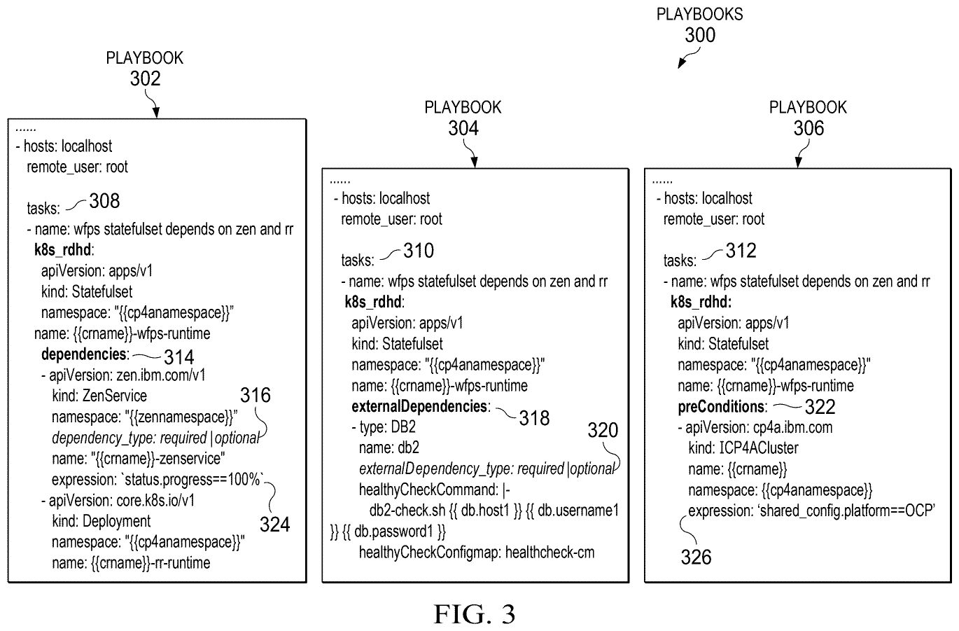

With reference now to FIG. 3, a diagram illustrating an example of playbooks is depicted in accordance with an illustrative embodiment. Playbooks 300 are implemented in operators, such as operators 212 in FIG. 2.

In this example, playbooks 300 include playbook 302, playbook 304, and playbook 306. Playbook 302, playbook 304, and playbook 306 can be, for example, YAML files or the like. Playbook 302 includes tasks 308, playbook 304 includes tasks 310, and playbook 306 includes tasks 312. Each of tasks 308, tasks 310, and tasks 312 represents a set of tasks. Each operator utilizes a resource deployment health dependency module (e.g., resource deployment health dependency module 228 in FIG. 2) to run playbook 302, playbook 304, and playbook 306; parse tasks 308, tasks 310, and tasks 312; and extract dependency rules from tasks 308, tasks 310, and tasks 312 to identify dependencies 314, dependency type 316, external dependencies 318, external dependency type 320, and preconditions 322. Dependency type 316 and external dependency type 320 are either required or optional. The resource deployment health dependency module also identifies other information, such as, for example, expression 324 and expression 326, in playbooks 300. It should be noted that the deployment developer creates the dependency rules for identifying the resource dependencies, external resource dependencies, resource dependency types, external resource dependency types, preconditions, expressions, and the like.

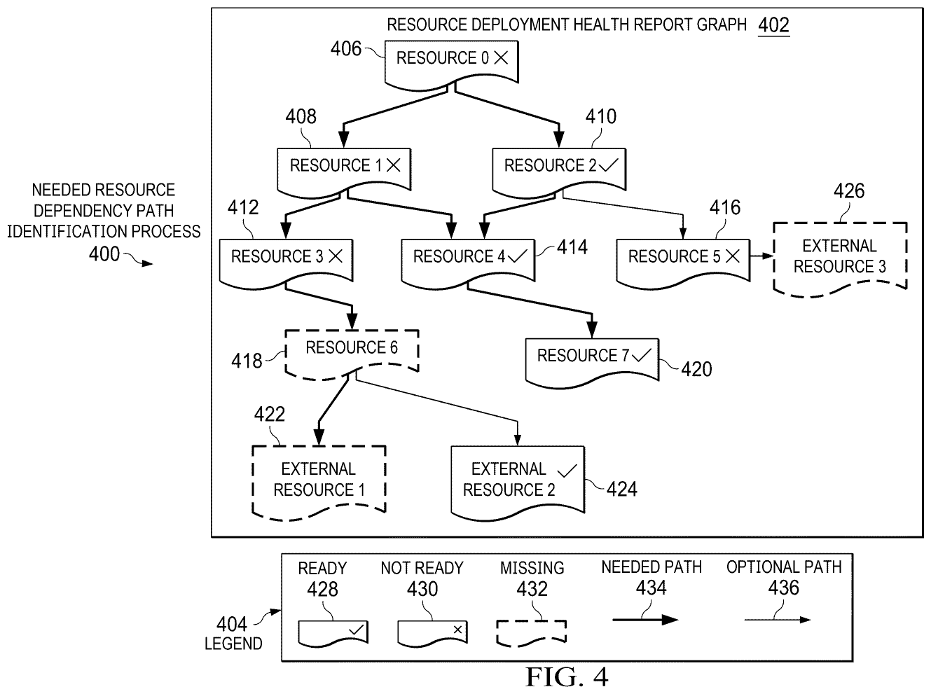

With reference now to FIG. 4, a diagram illustrating an example of a needed resource dependency path identification process is depicted in accordance with an illustrative embodiment. Needed resource dependency path identification process 400 is implemented in a computer, such as, for example, computer 101 in FIG. 1 or computer 202 in FIG. 2.

In this example, needed resource dependency path identification process 400 includes resource deployment health report graph 402 and legend 404. In this example, resource deployment health report graph 402 includes resource 0 406, resource 1 408, resource 2 410, resource 3 412, resource 4 414, resource 5 416, resource 6 418, resource 7 420, external resource 1 422, external resource 2 424, and external resource 3 426. The computer utilizes a virtual deployment controller, such as virtual deployment controller 218 in FIG. 2, to generate resource deployment health report graph 402. It should be noted that resource deployment health report graph 402 is intended as an example only and not as a limitation on illustrative embodiments. For example, resource deployment health report graph 402 can include any number of resources and external resources.

Legend 404 includes ready 428, not ready 430, missing 432, needed path 434, and optional path 436. Ready 428 indicates that a particular resource in resource deployment health report graph 402 is available in a ready state, and all its resource dependencies are in a ready state as well. Not ready 430 indicates either that particular resource itself is not in a ready state or one or more resource dependencies on which that particular resource depends on to run are not in a ready state. Missing 432 indicates that that particular resource does not currently exist in the container-based environment or remotely.

Needed path 434 indicates that a particular resource dependency path in resource deployment health report graph 402 is a critical or required resource dependency path among resources for the dependent resource to be in a ready state to provide needed core functionality (e.g., perform financial transactions). Optional path 436 indicates that a particular resource dependency path is a non-critical resource dependency path (e.g., provides logging or monitoring functionality) and does not impact functionality of the deployment. If only needed lines exist between resources in a particular resource dependency path, then that particular resource dependency path is a critical resource dependency path. For example, the resource dependency path from resource 0 406 to external resource 1 422 via resource 1 408, resource 3 412, and resource 6 418 is a critical resource dependency path. However, the resource dependency path from resource 6 418 to external resource 2 424 is a non-critical resource dependency path.

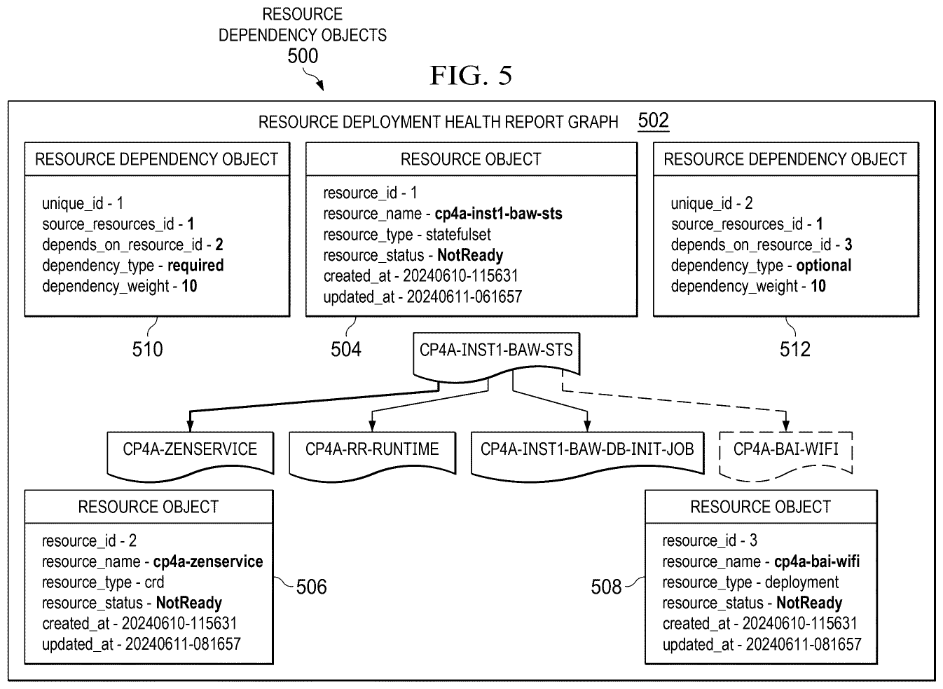

With reference now to FIG. 5, a diagram illustrating an example of resource dependency objects in a resource deployment health report graph is depicted in accordance with an illustrative embodiment. Resource dependency objects 500 are implemented in resource deployment health report graph 502, such as resource deployment health report graph 402 in FIG. 4.

In this example, resource deployment health report graph 502 includes resource object 504, resource object 506, resource object 508, resource dependency object 510, and resource dependency object 512. However, it should be noted that resource deployment health report graph 502 is intended as an example only and can include any number of resource objects, resource dependency objects, and other items not shown.

Each of resource object 504, resource object 506, and resource object 508 stores information regarding a corresponding resource of a specific deployment in the container-based environment. For example, each resource object contains a plurality of attributes that define the corresponding resource's unique identifier, name, type, current status, creation date, update date, and the like. Each of resource dependency object 510 and resource dependency object 512 stores dependency relationship information between resources (e.g., one resource depends on another resource to run). For example, each resource dependency object includes a unique object identifier, an identifier of a source resource (e.g., resource 1), an identifier of a resource dependency (e.g., resource 2 on which resource 1 depends on to run), dependency type (e.g., required or optional), a weight corresponding to the resource dependency, and the like. A computer, such as, for example, computer 101 in FIG. 1 or computer 202 in FIG. 2, needs this information to manage the resource dependencies within the container-based environment.

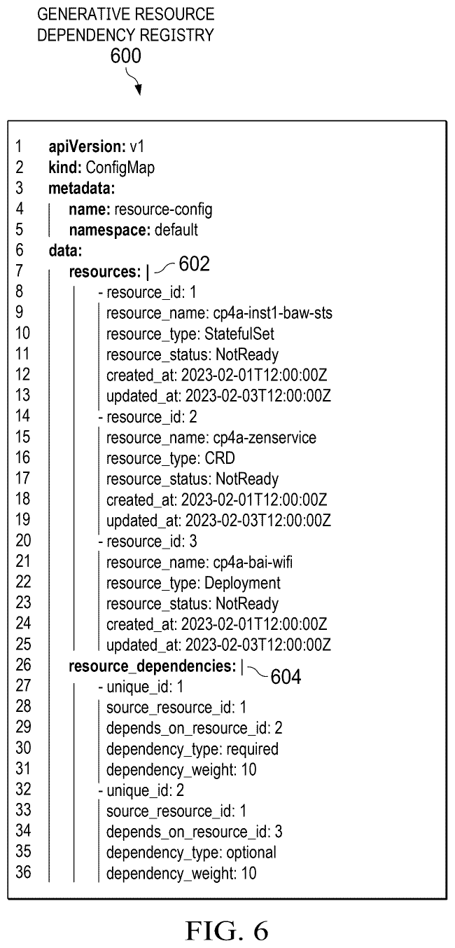

With reference now to FIG. 6, a diagram illustrating an example of a generative resource dependency registry is depicted in accordance with an illustrative embodiment. Generative resource dependency registry 600 is implemented in a computer, such as, for example, computer 101 in FIG. 1 or computer 202 in FIG. 2.

Generative resource dependency registry 600 combines information retrieved by a generative resource dependency controller, such as generative resource dependency controller 264 in FIG. 2, from resource objects and resource dependency objects contained in a resource deployment health report graph, such as resource object 504, resource object 506, resource object 508, resource dependency object 510, and resource dependency object 512 contained in resource deployment health report graph 502 in FIG. 5, to track resources 602 and corresponding resource dependencies 604 within the container-based environment. Generative resource dependency registry 600 captures the current status of each respective resource in resources 602, while resource dependencies 604 define dependency relationships between resources, enabling efficient management of resource dependencies. For example, generative resource dependency registry 600 is particularly useful for applications that need to enforce and validate resource dependencies before performing operations, such as, for example, generating or updating, to ensure that the container-based environment is in a secure state.

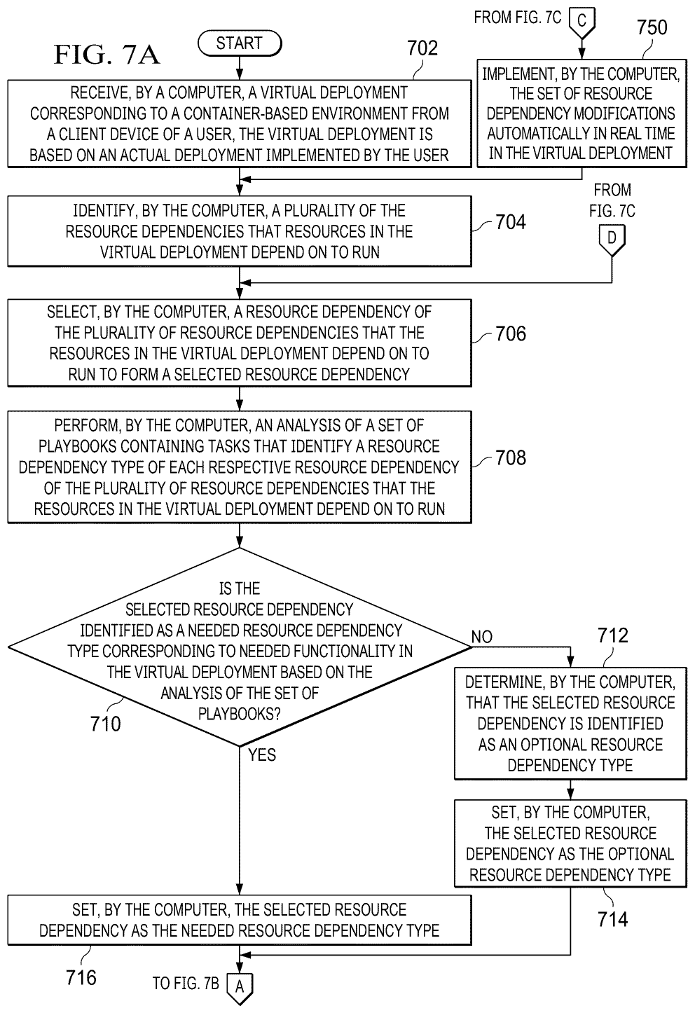

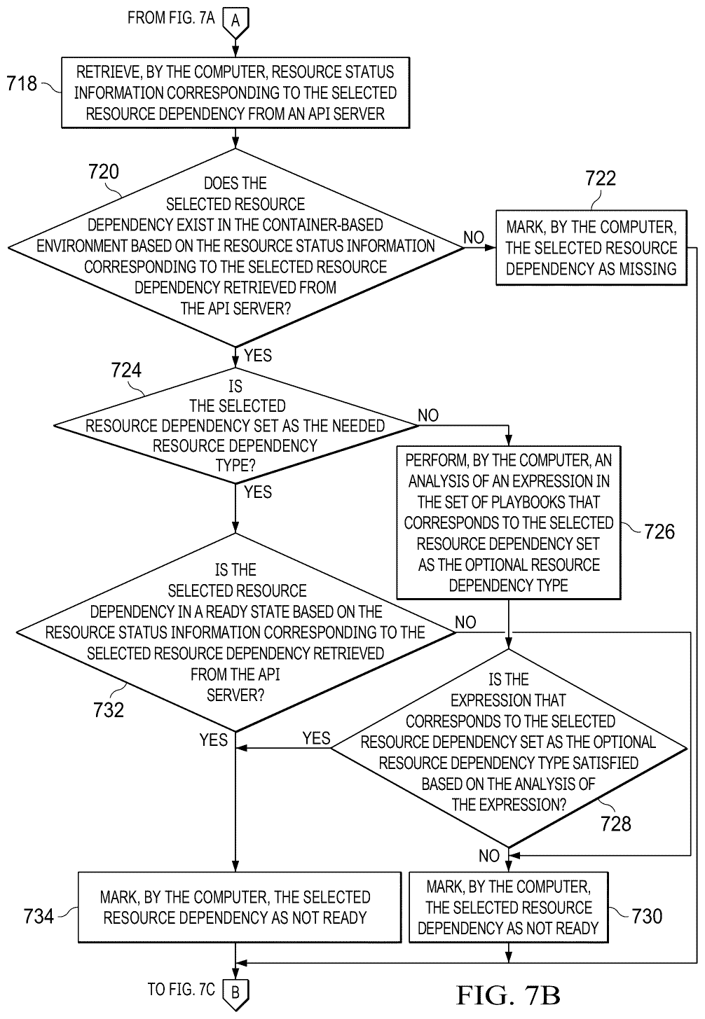

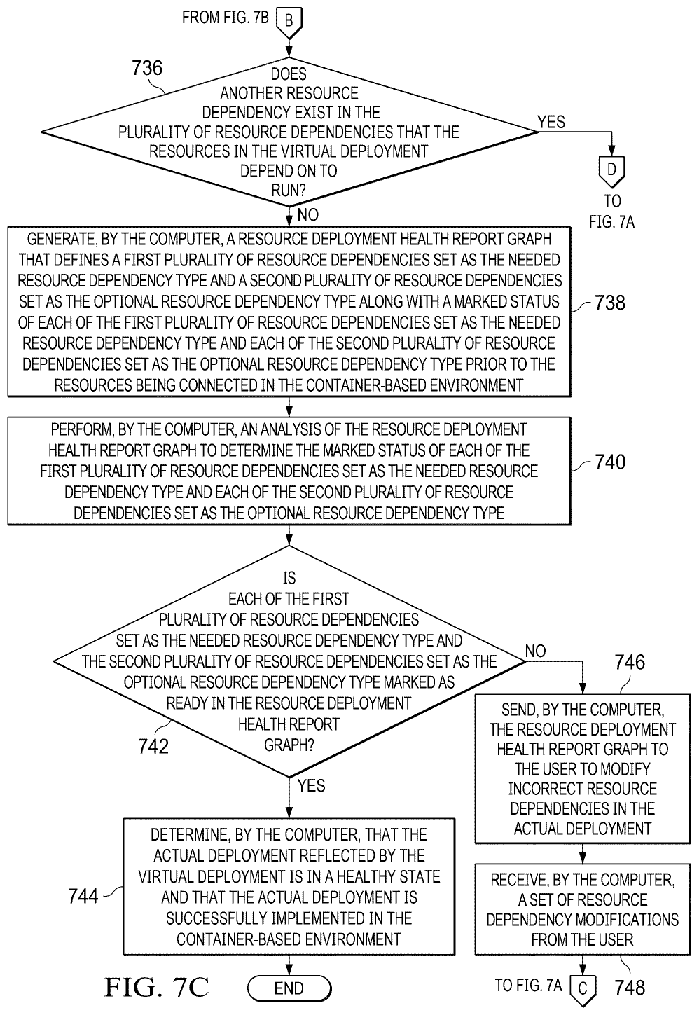

With reference now to FIGS. 7A-7C, a flowchart illustrating a process for identifying needed resource dependencies in container-based environments is shown in accordance with an illustrative embodiment. The process shown in FIGS. 7A-7C may be implemented in a computer, such as, for example, computer 101 in FIG. 1 or computer 202 in FIG. 2. For example, the process shown in FIGS. 7A-7C may be implemented by needed resource dependency identification code 200 in FIG. 1.

The process begins when the computer receives a virtual deployment corresponding to a container-based environment from a client device of a user (step 702). The virtual deployment is based on an actual deployment implemented by the user. In response to receiving the virtual deployment, the computer identifies a plurality of resource dependencies that resources in the virtual deployment depend on to run (step 704).

The computer selects a resource dependency of the plurality of resource dependencies that the resources in the virtual deployment depend on to run to form a selected resource dependency (step 706). The computer performs an analysis of a set of playbooks containing tasks that identify a resource dependency type of each respective resource dependency of the plurality of resource dependencies that the resources in the virtual deployment depend on to run (step 708).

The computer makes a determination as to whether the selected resource dependency is identified as a needed resource dependency type corresponding to needed functionality in the virtual deployment based on the analysis of the set of playbooks (step 710). If the computer determines that the selected resource dependency is not identified as a needed resource dependency type corresponding to needed functionality in the virtual deployment based on the analysis of the set of playbooks, no output of step 710, then the computer determines that the selected resource dependency is identified as an optional resource dependency type (step 712). Afterward, the computer sets the selected resource dependency as the optional resource dependency type (step 714). Thereafter, the process proceeds to step 718.

Returning again to step 710, if the computer determines that the selected resource dependency is identified as a needed resource dependency type corresponding to needed functionality in the virtual deployment based on the analysis of the set of playbooks, yes output of step 710, then the computer sets the selected resource dependency as the needed resource dependency type (step 716). Subsequently, the computer retrieves resource status information corresponding to the selected resource dependency from an API server (step 718).

The computer makes a determination as to whether the selected resource dependency exists in the container-based environment based on the resource status information corresponding to the selected resource dependency retrieved from the API server (step 720). If the computer determines that the selected resource dependency does not exist in the container-based environment based on the resource status information corresponding to the selected resource dependency retrieved from the API server, no output of step 720, then the computer marks the selected resource dependency as missing (step 722). Thereafter, the process proceeds to step 736.

Returning again to step 720, if the computer determines that the selected resource dependency does exist in the container-based environment based on the resource status information corresponding to the selected resource dependency retrieved from the API server, yes output of step 720, then the computer makes a determination as to whether the selected resource dependency is set as the needed resource dependency type (step 724). If the computer determines that the selected resource dependency is not set as the needed resource dependency type, no output of step 724, then the computer performs an analysis of an expression in the set of playbooks that corresponds to the selected resource dependency set as the optional resource dependency type (step 726). The computer makes a determination as to whether the expression that corresponds to the selected resource dependency set as the optional resource dependency type is satisfied based on the analysis of the expression (step 728). If the computer determines that the expression that corresponds to the selected resource dependency set as the optional resource dependency type is satisfied based on the analysis of the expression, yes output of step 728, then the process proceeds to step 734. If the computer determines that the expression that corresponds to the selected resource dependency set as the optional resource dependency type is not satisfied based on the analysis of the expression, no output of step 728, then the computer marks the selected resource dependency as not ready (step 730). Thereafter, the process proceeds to step 736.

Returning again to step 724, if the computer determines that the selected resource dependency is set as the needed resource dependency type, yes output of step 724, then the computer makes a determination as to whether the selected resource dependency is in a ready state based on the resource status information corresponding to the selected resource dependency retrieved from the API server (step 732). If the computer determines that the selected resource dependency is not in a ready state based on the resource status information corresponding to the selected resource dependency retrieved from the API server, no output of step 732, then the process returns to step 730 where the computer marks the selected resource dependency as not ready. If the computer determines that the selected resource dependency is in a ready state based on the resource status information corresponding to the selected resource dependency retrieved from the API server, yes output of step 732, then the computer marks the selected resource dependency as ready (step 734).

Afterward, the computer makes a determination as to whether another resource dependency exists in the plurality of resource dependencies that the resources in the virtual deployment depend on to run (step 736). If the computer determines that another resource dependency does exist in the plurality of resource dependencies that the resources in the virtual deployment depend on to run, yes output of step 736, then the process returns to step 706 where the computer selects another resource dependency from the plurality of resource dependencies. If the computer determines that another resource dependency does not exist in the plurality of resource dependencies that the resources in the virtual deployment depend on to run, no output of step 736, then the computer generates a resource deployment health report graph that defines a first plurality of resource dependencies set as the needed resource dependency type and a second plurality of resource dependencies set as the optional resource dependency type along with a marked status of each of the first plurality of resource dependencies set as the needed resource dependency type and each of the second plurality of resource dependencies set as the optional resource dependency type prior to the resources being connected in the container-based environment (step 738).

The computer performs an analysis of the resource deployment health report graph to determine the marked status of each of the first plurality of resource dependencies set as the needed resource dependency type and the second plurality of resource dependencies set as the optional resource dependency type (step 740). The computer makes a determination as to whether each of the first plurality of resource dependencies set as the needed resource dependency type and the second plurality of resource dependencies set as the optional resource dependency type is marked as ready in the resource deployment health report graph based on the analysis of the resource deployment health report graph (step 742).

If the computer determines that each of the first plurality of resource dependencies set as the needed resource dependency type and the second plurality of resource dependencies set as the optional resource dependency type is marked as ready in the resource deployment health report graph based on the analysis of the resource deployment health report graph, yes output of step 742, then the computer determines that the actual deployment reflected by the virtual deployment is in a healthy state and that the actual deployment is successfully implemented in the container-based environment (step 744). Thereafter, the process terminates. If the computer determines that each of the first plurality of resource dependencies set as the needed resource dependency type and the second plurality of resource dependencies set as the optional resource dependency type is not marked as ready in the resource deployment health report graph based on the analysis of the resource deployment health report graph, no output of step 742, then the computer sends the resource deployment health report graph to the user to modify incorrect resource dependencies in the actual deployment (step 746). Afterward, the computer receives a set of resource dependency modifications from the user (step 748). The computer implements the set of resource dependency modifications automatically in real time in the virtual deployment to form an updated virtual deployment (step 750). Thereafter, the process returns to step 704 where the computer identifies a plurality of resource dependencies in the updated virtual deployment.

Thus, illustrative embodiments of the present disclosure provide a computer-implemented method, computer system, and computer program product for identifying critical resource dependency paths and non-critical resource dependency paths to quickly resolve any deployment issues related to critical resource dependencies during an initial deployment in the container-based environment. The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
generating a resource deployment health report graph that defines a first plurality of resource dependencies set as a needed resource dependency type and a second plurality of resource dependencies set as an optional resource dependency type along with a status of each of the first plurality of resource dependencies set as the needed resource dependency type and of each the second plurality of resource dependencies set as the optional resource dependency type prior to resources being connected in a container-based environment;
performing an analysis of the resource deployment health report graph to determine the status of each of the first plurality of resource dependencies set as the needed resource dependency type and each of the second plurality of resource dependencies set as the optional resource dependency type;
determining whether each of the first plurality of resource dependencies set as the needed resource dependency type and the second plurality of resource dependencies set as the optional resource dependency type is marked as ready in the resource deployment health report graph based on the analysis of the resource deployment health report graph; and
responsive to determining that each of the first plurality of resource dependencies set as the needed resource dependency type and the second plurality of resource dependencies set as the optional resource dependency type is marked as ready in the resource deployment health report graph based on the analysis of the resource deployment health report graph, determining that an actual deployment in the container-based environment that is reflected by a virtual deployment corresponding to the container-based environment is in a healthy state and that the actual deployment is successfully implemented in the container-based environment.

2. The method of claim 1, further comprising:
responsive to determining that each of the first plurality of resource dependencies set as the needed resource dependency type and the second plurality of resource dependencies set as the optional resource dependency type is not marked as ready in the resource deployment health report graph based on the analysis of the resource deployment health report graph, sending the resource deployment health report graph to a user to modify incorrect resource dependencies in the actual deployment;
receiving a set of resource dependency modifications from the user; and
implementing the set of resource dependency modifications automatically in real time in the virtual deployment to form an updated virtual deployment.

3. The method of claim 1, further comprising:
receiving the virtual deployment corresponding to the container-based environment from a client device of a user, the virtual deployment is based on the actual deployment implemented by the user;
identifying a plurality of resource dependencies that the resources in the virtual deployment depend on to run;
selecting a resource dependency of the plurality of resource dependencies that the resources in the virtual deployment depend on to run to form a selected resource dependency; and
performing an analysis of a set of playbooks containing tasks that identify a resource dependency type of each respective resource dependency of the plurality of resource dependencies that the resources in the virtual deployment depend on to run.

4. The method of claim 3, further comprising:
determining whether the selected resource dependency is identified as the needed resource dependency type corresponding to needed functionality in the virtual deployment based on the analysis of the set of playbooks;
responsive to determining that the selected resource dependency is not identified as the needed resource dependency type corresponding to the needed functionality in the virtual deployment based on the analysis of the set of playbooks, determining that the selected resource dependency is identified as the optional resource dependency type; and
setting the selected resource dependency as the optional resource dependency type.

5. The method of claim 4, further comprising:
responsive to determining that the selected resource dependency is identified as the needed resource dependency type corresponding to the needed functionality in the virtual deployment based on the analysis of the set of playbooks, setting the selected resource dependency as the needed resource dependency type.

6. The method of claim 5, further comprising:
retrieving resource status information corresponding to the selected resource dependency from an application programming interface (API) server;
determining whether the selected resource dependency exists in the container-based environment based on the resource status information corresponding to the selected resource dependency retrieved from the API server; and
responsive to determining that the selected resource dependency does not exist in the container-based environment based on the resource status information corresponding to the selected resource dependency retrieved from the API server, marking the selected resource dependency as missing.

7. The method of claim 6, further comprising:
responsive to determining that the selected resource dependency does exist in the container-based environment based on the resource status information corresponding to the selected resource dependency retrieved from the API server, determining whether the selected resource dependency is set as the needed resource dependency type;
responsive to determining that the selected resource dependency is not set as the needed resource dependency type, performing an analysis of an expression in the set of playbooks that corresponds to the selected resource dependency set as the optional resource dependency type;
determining whether the expression that corresponds to the selected resource dependency set as the optional resource dependency type is satisfied based on the analysis of the expression; and
responsive to determining that the expression that corresponds to the selected resource dependency set as the optional resource dependency type is satisfied based on the analysis of the expression, marking the selected resource dependency as ready.

8. The method of claim 7, further comprising:
responsive to determining that the expression that corresponds to the selected resource dependency set as the optional resource dependency type is not satisfied based on the analysis of the expression, marking the selected resource dependency as not ready.

9. The method of claim 8, further comprising:
responsive to determining that the selected resource dependency is set as the needed resource dependency type, determining whether the selected resource dependency is in a ready state based on the resource status information corresponding to the selected resource dependency retrieved from the API server; and
responsive to determining that the selected resource dependency is not in the ready state based on the resource status information corresponding to the selected resource dependency retrieved from the API server, marking the selected resource dependency as not ready.

10. The method of claim 9, further comprising:
responsive to determining that the selected resource dependency is in the ready state based on the resource status information corresponding to the selected resource dependency retrieved from the API server, marking the selected resource dependency as ready.

11. A computer system comprising:
a processor set;
one or more computer-readable storage media; and
program instructions stored on the one or more computer-readable storage media to cause the processor set to perform operations comprising:
generating a resource deployment health report graph that defines a first plurality of resource dependencies set as a needed resource dependency type and a second plurality of resource dependencies set as an optional resource dependency type along with a status of each of the first plurality of resource dependencies set as the needed resource dependency type and of each the second plurality of resource dependencies set as the optional resource dependency type prior to resources being connected in a container-based environment;
performing an analysis of the resource deployment health report graph to determine the status of each of the first plurality of resource dependencies set as the needed resource dependency type and each of the second plurality of resource dependencies set as the optional resource dependency type;
determining whether each of the first plurality of resource dependencies set as the needed resource dependency type and the second plurality of resource dependencies set as the optional resource dependency type is marked as ready in the resource deployment health report graph based on the analysis of the resource deployment health report graph; and
responsive to determining that each of the first plurality of resource dependencies set as the needed resource dependency type and the second plurality of resource dependencies set as the optional resource dependency type is marked as ready in the resource deployment health report graph based on the analysis of the resource deployment health report graph, determining that an actual deployment in the container-based environment that is reflected by a virtual deployment corresponding to the container-based environment is in a healthy state and that the actual deployment is successfully implemented in the container-based environment.

12. The computer system of claim 11, wherein the operations further comprise:
responsive to determining that each of the first plurality of resource dependencies set as the needed resource dependency type and the second plurality of resource dependencies set as the optional resource dependency type is not marked as ready in the resource deployment health report graph based on the analysis of the resource deployment health report graph, sending the resource deployment health report graph to a user to modify incorrect resource dependencies in the actual deployment;
receiving a set of resource dependency modifications from the user; and
implementing the set of resource dependency modifications automatically in real time in the virtual deployment to form an updated virtual deployment.

13. The computer system of claim 11, wherein the operations further comprise:
receiving the virtual deployment corresponding to the container-based environment from a client device of a user, the virtual deployment is based on the actual deployment implemented by the user;
identifying a plurality of resource dependencies that the resources in the virtual deployment depend on to run;
selecting a resource dependency of the plurality of resource dependencies that the resources in the virtual deployment depend on to run to form a selected resource dependency; and
performing an analysis of a set of playbooks containing tasks that identify a resource dependency type of each respective resource dependency of the plurality of resource dependencies that the resources in the virtual deployment depend on to run.

14. The computer system of claim 13, wherein the operations further comprise:
determining whether the selected resource dependency is identified as the needed resource dependency type corresponding to needed functionality in the virtual deployment based on the analysis of the set of playbooks;
responsive to determining that the selected resource dependency is not identified as the needed resource dependency type corresponding to the needed functionality in the virtual deployment based on the analysis of the set of playbooks, determining that the selected resource dependency is identified as the optional resource dependency type; and
setting the selected resource dependency as the optional resource dependency type.

15. The computer system of claim 14, wherein the operations further comprise:
responsive to determining that the selected resource dependency is identified as the needed resource dependency type corresponding to the needed functionality in the virtual deployment based on the analysis of the set of playbooks, setting the selected resource dependency as the needed resource dependency type.

16. A computer program product comprising:
one or more computer-readable storage media; and
program instructions stored on the one or more computer-readable storage media to perform operations comprising:
generating a resource deployment health report graph that defines a first plurality of resource dependencies set as a needed resource dependency type and a second plurality of resource dependencies set as an optional resource dependency type along with a status of each of the first plurality of resource dependencies set as the needed resource dependency type and of each the second plurality of resource dependencies set as the optional resource dependency type prior to resources being connected in a container-based environment;
performing an analysis of the resource deployment health report graph to determine the status of each of the first plurality of resource dependencies set as the needed resource dependency type and each of the second plurality of resource dependencies set as the optional resource dependency type;
determining whether each of the first plurality of resource dependencies set as the needed resource dependency type and the second plurality of resource dependencies set as the optional resource dependency type is marked as ready in the resource deployment health report graph based on the analysis of the resource deployment health report graph; and
responsive to determining that each of the first plurality of resource dependencies set as the needed resource dependency type and the second plurality of resource dependencies set as the optional resource dependency type is marked as ready in the resource deployment health report graph based on the analysis of the resource deployment health report graph, determining that an actual deployment in the container-based environment that is reflected by a virtual deployment corresponding to the container-based environment is in a healthy state and that the actual deployment is successfully implemented in the container-based environment.

17. The computer program product of claim 16, wherein the operations further comprise:
responsive to determining that each of the first plurality of resource dependencies set as the needed resource dependency type and the second plurality of resource dependencies set as the optional resource dependency type is not marked as ready in the resource deployment health report graph based on the analysis of the resource deployment health report graph, sending the resource deployment health report graph to a user to modify incorrect resource dependencies in the actual deployment;
receiving a set of resource dependency modifications from the user; and
implementing the set of resource dependency modifications automatically in real time in the virtual deployment to form an updated virtual deployment.

18. The computer program product of claim 16, wherein the operations further comprise:
receiving the virtual deployment corresponding to the container-based environment from a client device of a user, the virtual deployment is based on the actual deployment implemented by the user;
identifying a plurality of resource dependencies that the resources in the virtual deployment depend on to run;
selecting a resource dependency of the plurality of resource dependencies that the resources in the virtual deployment depend on to run to form a selected resource dependency; and
performing an analysis of a set of playbooks containing tasks that identify a resource dependency type of each respective resource dependency of the plurality of resource dependencies that the resources in the virtual deployment depend on to run.

19. The computer program product of claim 18, wherein the operations further comprise:
determining whether the selected resource dependency is identified as the needed resource dependency type corresponding to needed functionality in the virtual deployment based on the analysis of the set of playbooks;
responsive to determining that the selected resource dependency is not identified as the needed resource dependency type corresponding to the needed functionality in the virtual deployment based on the analysis of the set of playbooks, determining that the selected resource dependency is identified as the optional resource dependency type; and
setting the selected resource dependency as the optional resource dependency type.

20. The computer program product of claim 19, wherein the operations further comprise:
responsive to determining that the selected resource dependency is identified as the needed resource dependency type corresponding to the needed functionality in the virtual deployment based on the analysis of the set of playbooks, setting the selected resource dependency as the needed resource dependency type.
